(19) United States
(12) Patent Application Publication
(10) Pub. No.: US 2009/0106077 A1
(43) Pub. Date: Apr. 23, 2009

(54) Facilitating in-transit meetings using location-aware scheduling

(75) Inventors: Kulvir Singh Bhogal, Fort Worth, TX (US); Travis M. Grigsby, Austin, TX (US); Renee Marie Kovales, Cary, NC (US); Robert Ross Peterson, Austin, TX (US); Lisa Anne Seacat, San Francisco, CA (US)

Correspondence Address: MOLLBORN PATENTS, INC., 2840 COLBY DRIVE, BOULDER, CO, 80305, US

(73) Assignee: International Business Machines Corporation, Armonk, NY (US)

(21) Appl. No.: 11/873,650

(22) Filed: Oct. 17, 2007

(51) Int. Cl. G06Q 10/00; G06F 17/40; G06F 19/00

(52) U.S. Cl. 705/9

(57) ABSTRACT

Methods and apparatus, including computer program products, implementing and using techniques for facilitating in-transit meetings between users. Transit information is received for several users. The transit information for at least some users is compared. If an opportunity for an in-transit meeting between at least two users is detected when comparing the transit information, the at least two users are notified about the opportunity for the in-transit meeting.

### BACKGROUND

This invention relates to electronic calendar systems. Electronic calendar systems have become an increasingly common work support tool, both within organizations and for private users. Typically, electronic calendar systems contain functionality for automatically checking electronic calendars of other users, such as members in a work team, for open time slots, proposing alterative meeting times, scheduling team meetings or appointments, and notifying and reminding invitees by email about their upcoming meetings.

With many tasks and events, there is significant associated travel time. Often this travel time has travelers finding themselves in far-off places where they will be for brief periods, such as in an airport somewhere for a flight layover, where for a time, they would be capable of having face-to-face meetings with other people, such as business contacts, coworkers, or clients. These opportunities to have face-to-face meetings are often lost because the travelers do not realize that such opportunities exist, and the people that the traveler could meet may not be aware that the traveler is available for a face-to-face meeting.

Two examples that illustrate this problem are as follows. In the first example, Alice has a long layover in Atlanta while traveling between Austin, Tex., and New York, N.Y. She has a business contact, Bob, in Atlanta that she would like to meet face to face. In the second example, Alice is traveling from Los Angeles, Calif., to New York, N.Y. Her business contact, Bob, is traveling the same day from Miami, Fla., to Seattle, Wash. During a brief period, they are actually co-located at the Denver, Colo., airport for layovers between flights. They try to arrange a meeting, but their calendars show that they are both traveling and that they are unavailable during that time. As a consequence, the opportunity to meet face to face gets lost. Thus, there is a need for improved calendar systems that can help identify and make use of such opportunities.

### SUMMARY

In general, in one aspect, the invention provides methods and apparatus, including computer program products, implementing and using techniques for facilitating in-transit meetings between users. Transit information is received for several users. The transit information for at least some users is compared to identify an opportunity for an in-transit meeting between at least two users. If an opportunity for an in-transit meeting is identified, one or more of the at least two users are notified about the opportunity for the in-transit meeting.

The invention can be implemented to include one or more of the following advantages. Increased opportunities for face-to-face meetings between people can be identified. Changes to transit times, layover airports, carriers, dates, seating within a flight, and so on, can be suggested in order to create increased opportunities for face-to-face meetings between people. In summary, planned and actual location and travel information can be used to improve individual productivity and time- and cost-efficiency, independent from how the location and travel information is acquired.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic flowchart of a process for identifying opportunities for meetings in accordance with one embodiment of the invention.

FIG. 2 shows an example of such a meeting list in accordance with one embodiment of the invention.

Like reference symbols in the various drawings indicate like elements.

### DETAILED DESCRIPTION

### Overview

The various embodiments of the invention described herein pertain to enhancements of electronic calendar systems. In particular, the electronic calendar systems are enhanced to contain location information during travel, as opposed to merely marking the travel time as “unavailable” for scheduling meetings, as is typical in conventional electronic calendaring systems. This makes it possible for users to arrange face-to-face, in-transit meetings, while traveling between two different places. The various embodiments of the invention will be described below by way of example of face-to-face meetings between two users, where at least one of the users is traveling. The mode of travel used in the examples below is air travel, but as the skilled person realizes, the ideas and techniques described herein are applicable to any method of travel that puts a person for some period of time in a place where it would be possible to have a face-to-face meeting with another person. The meetings can also, of course, be between more than two people. Furthermore, in order to render the following description more easily readable, these face-to-face meetings will be referred to below simply as “meetings.”

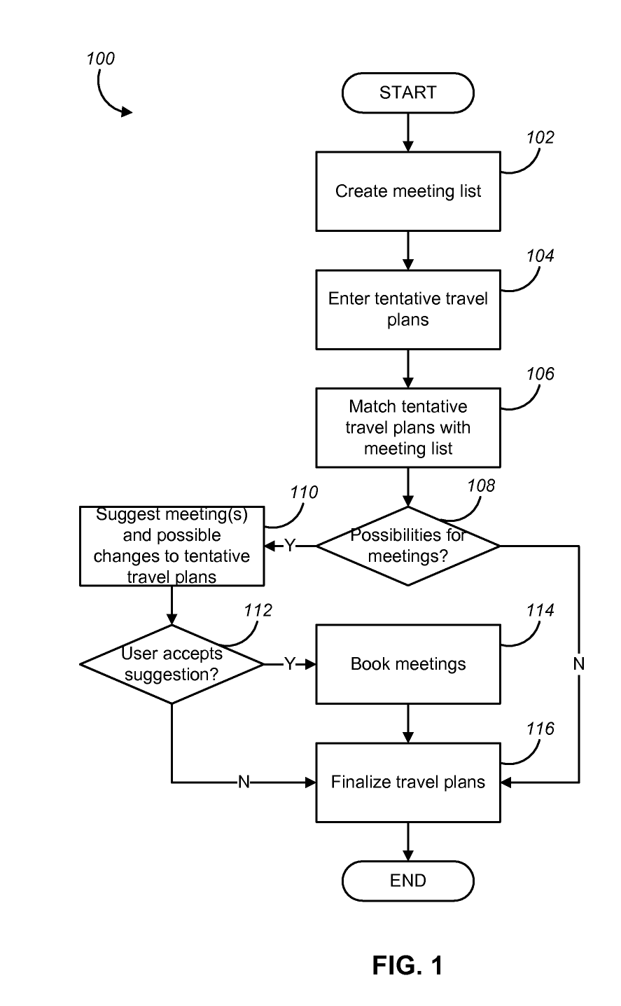

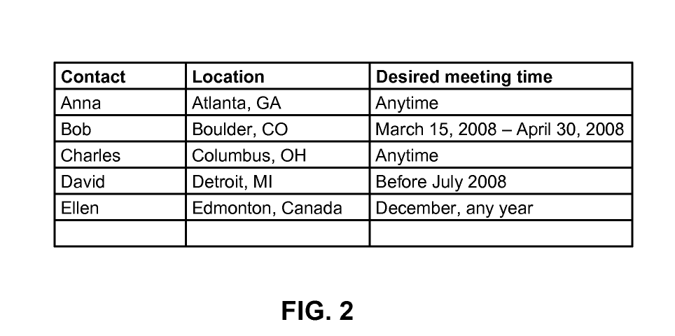

FIG. 1 shows a schematic flowchart of a process for identifying opportunities for meetings in accordance with one embodiment of the invention. As can be seen in FIG. 1, the process starts with a user creating a meeting list in her electronic calendar (step 102). One example of such a meeting list (200) can be seen in FIG. 2. The meeting list (200) contains a list of names of contacts, such as business contacts, clients, personal friends, and so on, with whom the user would like to have meetings.

As can be seen in FIG. 2, in one embodiment, the list has three columns. The left column lists the names of the people who the user would like to meet with, the middle column lists the geographical location of the contacts, and the right column lists a range of possible meeting times for when the user would like the meeting to occur. The geographical locations in the middle column are used by the electronic calendar system as the default location for a meeting, unless the corresponding contact has listed an alternative location, for example, if the contact is traveling themselves. The possible meeting times in the right column can be basically any time period that the user specifies. As can be seen in FIG. 2, the user is interested in meeting with Alice and Charles anytime it is feasible, maybe because they are personal friends. He is interested in meeting with Bob between Mar. 15 and Apr. 30, 2008, perhaps because they are working together on a project during that time. He is interested in meeting with David before July of 2008, as he knows that David will be retiring then, and he is interested in meeting with Ellen in the month of December, since that is usually when he passes through Edmonton on his way to his timeshare condo in Whistler, BC. As the skilled reader realizes, these are merely a few examples and many further variations are possible. For example, the user can specify groups of two or more people that he wants to meet with, but only if everyone is available at the same time and place for a face-to-face meeting, and so on.

Returning now to FIG. 1, after the user has entered his meeting list (200) into the electronic calendar system, the meeting list (200) resides there until the next time the user makes tentative travel plans (step 104). The travel plans will be discussed in more detail below, but they typically include information, such as, times and locations during travel, including appropriate info such as route, flight (or other transit) number, seat assignment, and so on. A large part of this information can be entered automatically in the electronic calendar by a travel reservation system in which the user books his trip, so that the user does not have to manually enter these details. This also minimizes the risk of the user accidentally entering the wrong information or omitting certain details about the travel plans.

Next, once the tentative travel plans have been entered, they are checked against the contacts on the meeting list (200) (step 106). Based on the parameters entered in the tentative travel plans and the parameters entered in the meeting list (200), the process determines whether there are any possibilities for in-transit meetings between the user and one or more of his contacts (step 108). If there are no such possibilities, then the travel plans are finalized (step 116) and the process ends.

If it is determined in step 108 that there are possibilities for meetings, the user is presented with some proposed meetings and possibly with some minor changes to the tentative travel itinerary that would allow the user to accommodate one or more in-transit meetings (step 110). The process then waits for the user to accept or reject the proposal (step 112). If the user accepts the proposal, the meetings are booked (step 114) and the travel plans are finalized (step 116), possibly with some minor changes to the itinerary, as indicated in step 110. If the user does not find the proposal acceptable, no meetings are booked, and the travel plans are finalized (step 116). This ends the process (100). The above techniques will now be described in more detail using a couple of use scenarios to enhance the understanding of the different embodiments of the invention.

### Use Scenario 1: Modification During Trip Booking Due to Meeting List

This use scenario illustrates how the electronic calendar system can recommend travel reservation to accommodate a meeting. Assume that Alice adds Bob to her meeting list (200) of people to meet face to face in her electronic calendaring software. Next, when Alice attempts to reserve a flight on Delta Airlines through Cincinnati, Ohio, using her travel reservation software application, the travel software application checks the electronic calendars of the people in Alice's meeting list, and discovers that Bob will be flying through Atlanta, Ga., that same day. As a result, the travel software application proposes an alternative itinerary to Alice, which will take Alice through Atlanta instead and at a time that overlaps with Bob's layover at the airport, thus creating an opportunity for Alice and Bob to meet. If Alice accepts this proposed itinerary, a message is sent to Bob with Alice's travel information. In some embodiments, the message can also interact with a meeting room reservation system at the airport, and automatically reserve a meeting room for Bob and Alice for a particular time and include these details in a notification to Bob and Alice. Alternatively, in some embodiments, Bob is merely notified that Alice will be in the same airport as himself during the layover, and it is up to Bob and Alice to initiate contact and determine a time and a place to meet during the layover.

### Use Scenario 2: Modification to a Planned Trip to a Meeting List Change

This use scenario illustrates how a planned trip can be modified as a result of a change to the meeting list (200). Assume that Alice has booked a trip to New York, N.Y., flying through Cincinnati, Ohio, on Delta Airlines. At some point after the trip has been booked, Alice adds Bob to her meeting list (200) that is capable of interacting with her travel software application. After adding Bob, the travel software application looks at both Alice's and Bob's calendars and recommends that she change her itinerary to fly through Atlanta (and recommends a time) because Bob is flying through Atlanta that same day. If Alice decides to accept the suggestion, Bob is notified, as described in the above use scenario.

### Recommending Changes to Travel Plans

In the various embodiments of the invention, there are a number of considerations that may go into recommending itineraries or proposing changes to existing itineraries, as was described in the above use scenarios, and in step 110 of FIG. 1. Some of these considerations will be discussed below. It should be noted that this is by no means an exhaustive list, but rather a number of examples of possible considerations that can be taken into account when proposing alternative itineraries. Many variations and additions to this list will be apparent to those of ordinary skill in the art. The considerations listed below are all based on that one party generates a list of contacts that he is not normally co-located with, yet wishes to meet face to face. The software application in accordance with one embodiment of the invention looks at the electronic calendars of each person in the list and makes moves as necessary to enable and maximize temporary co-location as follows.

Same travel date, same city: If parties that wish to meet are traveling on the same day and have the same city on their itineraries, the software application can recommend changes to one party's flight times to correspond with the other party, such that they reach the common city within, for example, half an hour of each other.

Same travel date, same airline: If the parties are traveling on the same day with the same airline, but laying over in different cities, the software application can recommend changes causing the parties' layover cities to coincide.

Same travel date, different airlines: If the parties are traveling on the same day but with different airlines, the software application recommend changes to switch one or both parties to different airlines in order to allow the same layover cities, and/or flights.

Different travel dates: If the parties are not traveling on the same date, the software application can recommend changes to the travel dates for one or both parties to allow for additional time of co-availability and schedule for the same layover city, and so on.

Same travel date, same flight: If the parties are already booked on the same flight, then the software application can recommend changes to the seat assignments for one or both parties in order to allow the parties to be seated next to each other during the flight.

Prioritizing contacts: Some embodiments include the option of assigning priorities to the contacts in the meeting list (200), to indicate certain meetings that might be more important than others. If such a prioritized meeting list (200) is used, the priorities can be taken into account when suggesting changes to itineraries. For example, when one party makes a flight reservation, the software application can examine the prioritized meeting list (200) in the order of the priorities to obtain the other parties travel information, and recommend a transit option that allows for an in-transit meeting with the highest priority party.

### Further Considerations

In some implementations it is possible to subscribe to RSS feeds for flight statuses. For example, if two parties have arranged an in-transit meeting and the flight information would change for some reason for either party, a notification can be sent to one or both parties notifying them about the changes.

Conversely, the RSS feed update can also lead to increased opportunities for meetings. For example due to a flight status change, an in-transit meeting opportunity can become available with a party on the meeting list that was not previously possible. In such a case the parties can be notified, for example, by an email or SMS message, or similar notification method.

It is desirable to allow an electronic calendar user to be aware that their existing itinerary overlaps with another person's itinerary, thus providing the opportunity for a meeting that might not take place otherwise. For example, if a user is in Terminal A of the Dallas, Tex., airport between 3 p.m. and 4 p.m. for a layover, and Charles on the user's meeting list (200) happens to be in terminal B of the same airport during the same time (and the user did not know this), the user could be notified that he has the opportunity to see Charles in the airport and meet up with him. The notification can be made by any conventional means, such as SMS, email, page, or the like.

### Implementation Considerations

As the skilled reader realizes, in order to facilitate the communication between travel reservation systems and the electronic calendar systems for a large number of users, and to receive a widespread adoption of the embodiments of the invention as described above, it is important for the various systems to be able to communicate using a standardized format. One example of such a format is XML (Extended Markup Language), and in particular the Travel XML specification by the Open Travel Alliance (OTA), which serves as a common language for travel-related terminology and a mechanism for exchanging information across travel industry segments.

Once the calendar information and the travel information for each user is expressed in such a standardized format and stored in some kind of repository, it is a relatively straightforward task to match the information between users and to achieve the functionality described above. For example, in one implementation, a software application takes the entered travel information for a new trip and performs a query against a database that contains the existing calendar and travel information. The query pulls only the records that correspond to the users on the meeting list, provided that the users have allowed the owner of the meeting list to “see” their calendar and travel information. Typically, only travel-related records are compared, but it is of course possible to compare other records as well if there would be other reasons to do so. The query can be further limited, if desired, based on various parameters relating to the proposed travel reservations, such as time of day, airline, and so on. It should be noted that in some implementations, the comparison needs to be done only when a user is making travel arrangements. In other implementations, batch processing can be done, for example, to have a notification system informing the user that “Joe will be at RDU from 3:30 p.m.-5:00 p.m. on Oct. 10, 2007 in Terminal C. This coincides with your travel plans.” Furthermore, in the event that there are mismatches between calendars and/or travel reservation systems, various conversion technologies, such as XSLT (Extensible Stylesheet Language Transformation), and so on, can be used to overcome such issues.

The functionality described above can be provided as a software product or as a service provided by, for example, airlines, travel websites, corporate travel software, social networking websites, general services websites, and so on. In the event that an airline reservation system provides the input, it may even be possible to avoid the use of individual calendars. For example, the airline reservation system can include a mechanism for users to define a user profile, in which the users can specify their meeting list and set permissions for who is allowed to view information related to the user's profile. Thus when a user makes a travel reservation, the existing travel reservations for other users can be used in the comparison, as opposed to having to retrieve the calendar entries referred to above. In the event that a social networking website or a general services website offers the above functionality as a service, the service can store user preference information that includes the meeting list. Recommendations for travel reservations can then be displayed to the users based on the preferences. The actual travel reservation can either be integrated with the general services website or be performed as a separate process from the recommendations provided by the service.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, the meeting list used in the examples above does not have to be a separate list. Instead, the desired meeting times can be integrated as an extra field for each contact in a contact address book, which is a common features of most electronic calendar systems. The in-transit meeting feature can also be turned on or off at the user's request, in the event that the user is not interested in finding out about opportunities for in-transit meetings, and would rather have the travel time reserved to work on his on projects or to relax.

The above embodiments have been described in the context of air travel and meetings between two people only. However, as the skilled person realizes, the underlying ideas are applicable to any means of travel and any number of people, so the invention is not limited to the above embodiments. For example, trains and train stations and buses and bus terminals are two common examples of possible in-transit meeting locations. Furthermore, the meetings have been described as in-transit meetings, but these should not be interpreted as occurring only during layovers. Such meetings can equally well occur at the beginning (e.g., the starting location or origin airport) or the end (the ending location or destination airport) of a trip.

The current locations of users do not have to be determined through comparing calendar information, as was described above. Other methods for establishing current locations of users include, for example, the use of location sensors, such as mobile devices with GPS (Global Positioning System) functionality, E911 (Enhanced 911) functionality, RFID (Radio Frequency Identification) functionality, and so on. The meeting list was described above as being created by a user. However, the meeting list can also very well be supplied to the user through some other kind of mechanism. For example, a corporate directory can be used, and the user can specify, for example, anyone who works in the sales department, or any person who works for John Doe, and so on, rather than specifying individuals. All of the above-mentioned operations can of course also be controlled by additional preferences that are specific to corporations, departments, groups, users, and so on. Accordingly, other embodiments are within the scope of the following claims.

1. A computer-implemented method for facilitating in-transit meetings between users, the method comprising:
receiving transit information for a plurality of users;
identifying an opportunity for an in-transit meeting between at least two users by comparing the transit information for at least some users in the plurality of users; and
in response to identifying an opportunity for an in-transit meeting, notifying one or more of the at least two users about the opportunity for the in-transit meeting.

2. The method of claim 1, wherein identifying an opportunity for an in-transit meeting includes identifying overlapping transit information for the at least two users.

3. The method of claim 1, wherein identifying an opportunity for an in-transit meeting includes identifying a possibility to create overlapping transit information between the at least two users by modifying the transit information for one or more of the at least two users.

4. The method of claim 3, further comprising:
providing recommendation to one or more of the at least two users of modifications to be made to a travel itinerary;
receiving a user input from the one or more users accepting the recommendation; and
modifying the travel itinerary for the one or more users in response to the one or more users accepting the recommendation

5. The method of claim 4, wherein modifying the travel itinerary for the one or more users includes one or more of:
changing a travel route, changing a travel carrier, changing a layover location, changing a departure time, changing an arrival time, changing a layover time interval, changing a travel date, and changing a seat assignment.

6. The method of claim 1, wherein receiving transit information includes receiving a calendar entry pertaining to a travel itinerary for a user in an electronic calendar system.

7. The method of claim 1, wherein the transit information includes one or more of:
a travel route, a travel carrier, a departure location, a destination location, a layover location, a departure time, an arrival time, a layover time interval, a travel date, and a seat assignment.

8. The method of claim 1, wherein:
each user has an associated meeting list including identities of users with whom the user would like to arrange in-transit meetings; and
comparing the transit information for at least some users in the plurality of users includes comparing the transit information for the user and the transit information for at least one of the users in the meeting list.

9. The method of claim 8, wherein:
each user on the meeting list has an associated priority; and
comparing the transit information is done in an order that is based on the priority for each user in the meeting list.

10. The method of claim 1, wherein the transit information is expressed in an Extended Markup Language format.

11. The method of claim 1, further comprising:
reserving a meeting facility for the in-transit meeting, based on the detected opportunity for the in-transit meeting.

12. The method of claim 1, wherein receiving transit information includes receiving real-time user location information.

13. The method of claim 1, further comprising:
receiving status updates for changes to the transit information; and
determining whether the status updates have any impact on the opportunity for the in-transit meeting; and
in response to determining that there is an impact on the opportunity for the in-transit meeting, notifying one or more users affected by the status updates.

14. A computer program product comprising a computer useable medium including a computer readable program, wherein the computer readable program when executed on a computer causes the computer to:
receive transit information for a plurality of users;
identify an opportunity for an in-transit meeting between at least two user by comparing the transit information for at least some users in the plurality of users; and
in response to identifying an opportunity for an in-transit meeting, notify one or more of the at least two users about the opportunity for the in-transit meeting.

15. The computer program product of claim 14, wherein identifying an opportunity for an in-transit meeting includes identifying overlapping transit information for the at least two users.

16. The computer program product of claim 14, wherein identifying an opportunity for an in-transit meeting includes identifying a possibility to create overlapping transit information between the at least two users by modifying the transit information for one of the at least two users.

17. The computer program product of claim 16, further causing the computer to:
provide recommendation to one or more of the at least two users of modifications to be made to a travel itinerary;
receive a user input from the one or more users accepting the recommendation; and
modify the travel itinerary for the one or more users in response to the one or more users accepting the recommendation

18. The computer program product of claim 17, wherein modifying the user's travel itinerary includes one or more of:
changing a travel route, changing a travel carrier, changing a layover location, changing a departure time, changing an arrival time, changing a layover time interval, changing a travel date, and changing a seat assignment.

19. The computer program product of claim 14, wherein the transit information includes one or more of:
a travel route, a travel carrier, a departure location, a destination location, a layover location, a departure time, an arrival time, a layover time interval, a travel date, and a seat assignment.

20. A system for facilitating in-transit meetings between users, comprising:
means for receiving transit information for a plurality of users;
means for identifying an opportunity for an in-transit meeting between at least two users by comparing the transit information for at least some users in the plurality of users; and
means for notifying one or more of the at least two users about the opportunity for the in-transit meeting in response to identifying an opportunity for an in-transit meeting.
